(19) United States
(12) Patent Application Publication
(10) Pub. No.: US 2004/0128924 A1
(43) Pub. Date: Jul. 8, 2004

(54) Glazing panel installation structure and method

(76) Inventors: Michael D. Kobrehel, Elkhart, IN (US); Daryl F. Dankert, Mishawaka, IN (US); Leroy C. Schmuck, Kendallville, IN (US); Todd E. Cripe, Goshen, IN (US); Harley Rensch, Corunna, IN (US); Kip B. Ellis, Goshen, IN (US)

Correspondence Address: JOHN R. BENEFIEL, 280 DAINES ST., #100 B, BIRMINGHAM, MI, 48009, US

(21) Appl. No.: 10/646,468

(22) Filed: Aug. 20, 2003

Related U.S. Application Data
(60) Provisional application No. 60/404,666, filed on Aug. 20, 2002.

(51) Int. Cl. E06B 3/28; E06B 3/26

(52) U.S. Cl. 52/203; 52/202

(57) ABSTRACT

An installation structure and method for installing and removing a sacrificial glazing panel in a frame having a perimeter channel in which a deeper channel section is formed in the frame receiving an edge of the glazing panel to allow forcible shifting of the glazing panel so that an opposite edge clears the lip of an opposite channel section during installation and removal. A positioner element such as bowed leaf spring may be installed to reposition the glazing panel after the glazing panel is released so that the opposite edge is located to be retained by the lip after release.

### CROSS REFERENCE TO RELATED APPLICATIONS

This application claims the benefit of U.S. provisional Serial No. 60/404,666, filed Aug. 20, 2002.

### BACKGROUND OF THE INVENTION

This invention concerns glazing installations and methods, particularly relating to so called sacrificial glazing panels. These are readily replaceable protective glazing panels typically used on buses to protect the primary glazing panel. The primary glazing panel is usually formed of heavy tempered plate glass, and is sealed to prevent the entrance of water, dirt, etc., so as to be expensive and difficult to replace.

The primary glazing panel is subject to wear, abuse, and vandalism, and thus thinner clear plastic “sacrificial” glazing panels have heretofore been installed, adjacent to or spaced from the primary glazing panel. Such sacrificial panels are lower in cost to make and to replace and thereby lower maintenance costs. The installation and removal of such glazing panels has in the past required separate retainer parts and/or the use of special tools, such that replacement still incurs a significant maintenance cost.

It is the object of the present invention to provide a sacrificial glazing panel installation structure and method which simplifies the replacement of such a panel.

### SUMMARY OF THE INVENTION

The above recited object and others which will be understood upon a reading of the specification and claims are achieved by providing a generally rectangular frame having a perimeter channel which is configured to receive a correspondingly configured thin plastic sacrificial glazing panel. The sacrificial glazing panel is sized relative to the frame perimeter channel such that upon being bowed to bring a pair of opposite edges together, another edge of the panel is able to be inserted into a receiving channel section. The perimeter channel is deeper in the receiving section to allow substantial vertical (or sideways) movement of the panel once the sacrificial glazing panel is inserted into the frame perimeter channel in order that an opposite glazing panel will clear the edge lip portion of the associated channel section. Allowing the glazing panel to lie completely within the frame.

In one embodiment, resiliently compressible positioner elements are disposed in the bottom of the receiving channel section to reposition the installed sacrificial glazing panel so as to locate the inserted panel edge well within a retainer lip of the receiving channel section. Forcible downward movement of the sacrificial glazing panel inserted edge is accommodated by the compressible positioner element to enable the opposite edge to clear the lip portion of the opposite channel section and allow the panel to be completely received into the frame. Complete removal of the sacrificial panel is enabled upon a subsequent outward bowing thereof which draws the pair of opposite panel edges together sufficiently to clear the lip portions of an associated pair of channel sections, so that the panel can be tilted and lifted out of the frame.

The resiliently compressible positioner elements preferably comprise wave springs engaging the lower edge of the sacrificial glazing panel, but may also can take other forms, such as compressible foam strips, compressible elastomeric seals or spring and slider assemblies.

In an alternative embodiment, removable plugs are inserted into the lip of a lower channel section comprising the deeper receiving channel section. The bottom edge of the sacrificial glazing panel rests on the plugs to be held elevated in the deeper bottom channel section so that the top edge is retained by the lip of the top channel section. Removal of the plugs allows the sacrificial glazing panel to be lowered sufficiently so that the upper edge clears the top channel section lip portion, in preparation for removal of the panel.

In another embodiment, the deeper channel section is in the top channel section to eliminate the need for positioner elements.

### DESCRIPTION OF THE DRAWINGS

FIG. 1 is a vertical sectional view of a window having upper and lower glazing assemblies each including a sacrificial glazing panel installation according to the invention.

FIG. 2 is a front view of the window shown in FIG. 1.

FIG. 3 is a fragmentary view of a horizontal section taken through the window shown in FIG. 2.

FIG. 4 is a fragmentary sectional view of an alternate embodiment of the sacrificial glazing panel installation according to the invention.

FIG. 5 is a fragmentary section view of a second alternate embodiment of the sacrificial glazing panel installation according to the invention.

FIG. 6 is a fragmentary section view of a third alternate embodiment of the sacrificial glazing panel installation according to the invention.

FIG. 7 is a fragmentary section view of a fourth alternate embodiment of the sacrificial glazing panel installation according to the invention.

FIG. 8 is a view of the sacrificial glazing panel installation shown in FIG. 7, but with the positioner plugs removed.

FIG. 9 is a front view of a window having sideways movable glazing panels incorporating the sacrificial glazing panel installation according to the invention.

FIG. 10 is a view of the section 10-10 taken in FIG. 9.

FIG. 11 is a view of the section 11-11 taken in FIG. 9.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

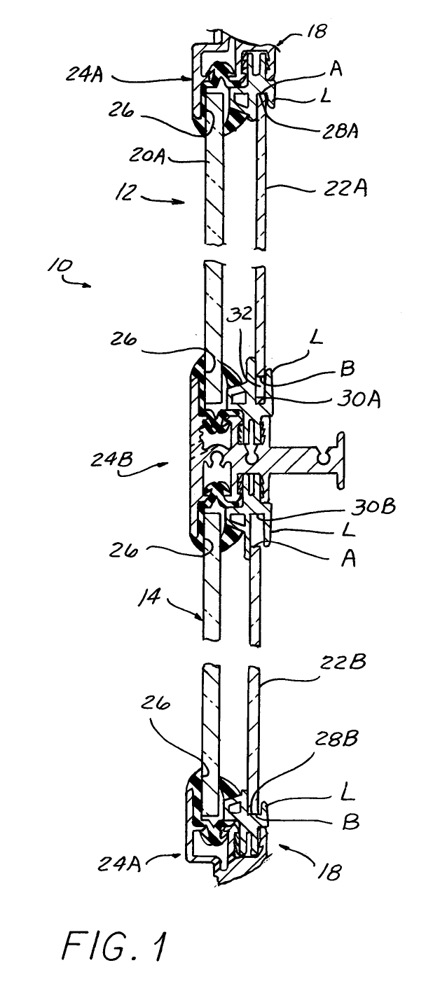

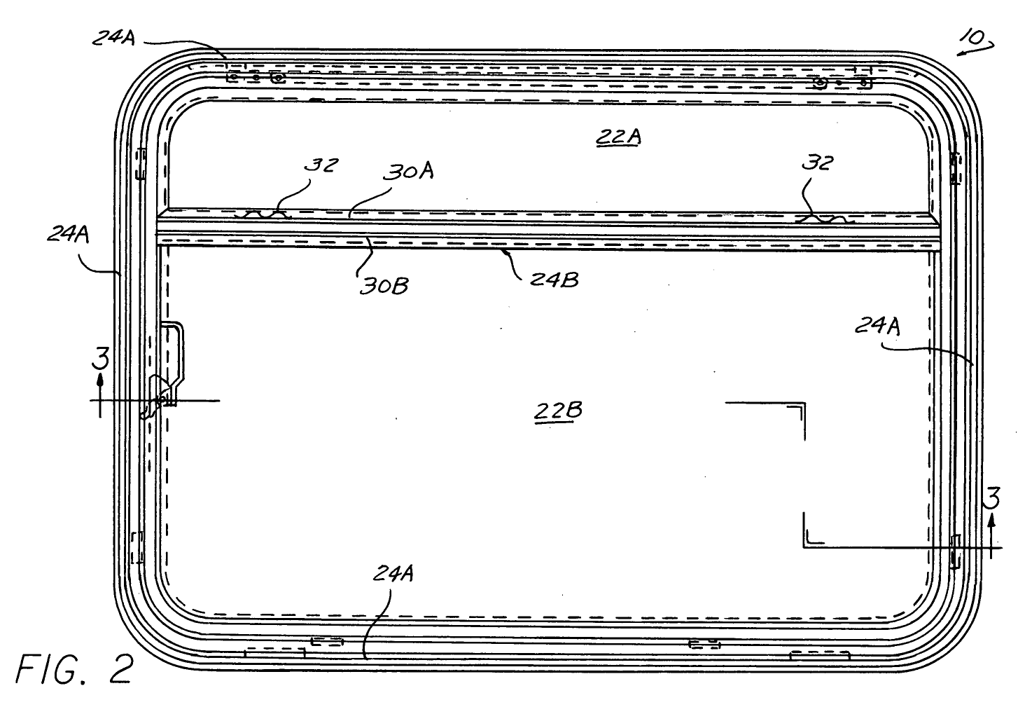

Referring to the drawings, and particularly FIGS. 1-3, a vehicle window 10 is depicted which includes an upper glazing assembly 12 and a lower glazing assembly 14 mounted in a vehicle body (not shown).

A frame and seal assembly 18 mounts the window 10 in the vehicle body (not shown), which assembly does not form a part of the present invention and hence will not be here described in detail.

Primary glazing panels 20A, 20B and associated seals are carried in a retainer frame comprised of retainer perimeter frame sections 24A and straight mullion frame sections 24B, each defining perimeter channels 26 receiving the primary glazing panels 20A, 20B. The primary glazing panels 20A, 20B are typically constructed of tempered glass, laminated glass or thick polycarbonate plastic.

The retainer frame sections 24A, 24B also mount generally rectangular sacrificial glazing panels 22A, 22B, each having top, bottom and side edges A, B, C, D, each edge received in an associated perimeter channel section defined by the respective retainer sections 24A and 24B.

Upper channels 28A, 28B and lower channels 30A, 30B are formed in part by outer lip portions L which define a glazing opening smaller in size than the size of the sacrificial glazing panels 22A, 22B.

The mullion channel sections 30A, 30B are deeper than the perimeter channel sections 28A, 28B to create a vertical clearance for sliding movement of the sacrificial glazing panels 22A, 22B in the retainer frame during installation and removal thereof.

The upper mullion channel section 30A has a pair of curved double bowed leaf springs 32 installed in the bottom thereof which act to reposition the lower edge B of sacrificial glazing panel 22A of an intermediate position in the channel section 28 after downward pressure of the glazing panel 22A has been released, so that the top edge A of the panel is raised to again be located within the channel lip L and securely retained in the channel section 28A disposed thereabove.

The sacrificial glazing panels 22A, 22B are constructed of a relatively thin (±⅛ inch) plastic, such as acrylic, of a greater size than the opening defined by the inside of the retaining lips L, but of a size such that when the center of the panel 22A, 22B is bowed, as with the use of a pair of handled suction cups, the side edges C, D are drawn in to allow one edge to be inserted in a receiving channel section, i.e., channel section 30A or 30B.

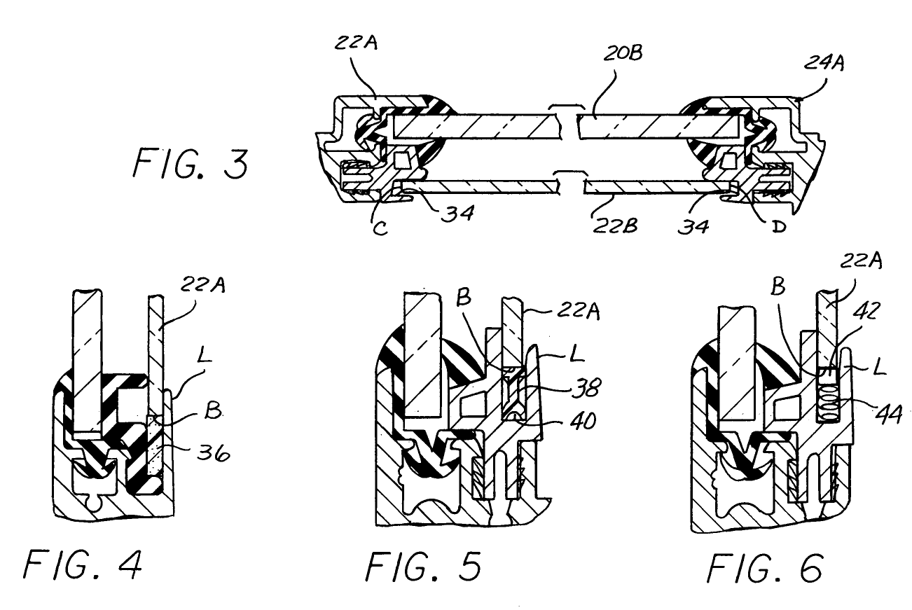

The top and bottom channel sections 28A, B are shallower than the opposing mullion channels 30A, 30B, so that when one edge of the sacrificial glazing panel 22A or 22B is first inserted and moved sufficiently towards the bottom of the respective channel 30A, 30B, the opposite edge clears the lip L of the respective channel section 28A, 28B, to allow the glazing panel 22A or 22B to be completely moved into the frame. Upon release, the side edges C, D of the sacrificial glazing panel 22A, 22B move apart to be received and retained in the associated side channels 34 (FIG. 3) of the perimeter frame sections 24.

To remove, the sacrificial glazing panel 22A is forcibly pressed downwardly, compressing double bowed leaf springs 32 moving the top edge A down sufficiently to clear the lip L of the associated channel section 28A. The sacrificial glazing panel 22A is bowed to draw together side edges C, D to clear the lip L of the side channels 34 and allow the sacrificial glazing panel 22A to be tilted and lifted out.

The bottom edge B of the lower sacrificial glazing panel 22B is gravity biased down into the channel section 28B, and the panel 22B thus need only be lifted up until the bottom edge clears the associated channel section lip L and the panel 22A is then bowed to allow tilting out and removal. Thus, a positioner element is not necessary to retain of the top edge.

FIG. 4 shows an arrangement of compressible foam pieces 36 positioned engaging the lower edge B of the upper sacrificial glazing panel 22A to hold the same in the channel 28A.

FIG. 5 shows a compressible elastomeric element 38 which has a space 40 allowing downward movement when removing the sacrificial glazing panel 22A.

FIG. 6 shows a slide 42 and compression spring 44 engaging the underside of the slide 42 to urge the same up to position the upper edge of the sacrificial glazing panel 22A within the upper channel section 28A.

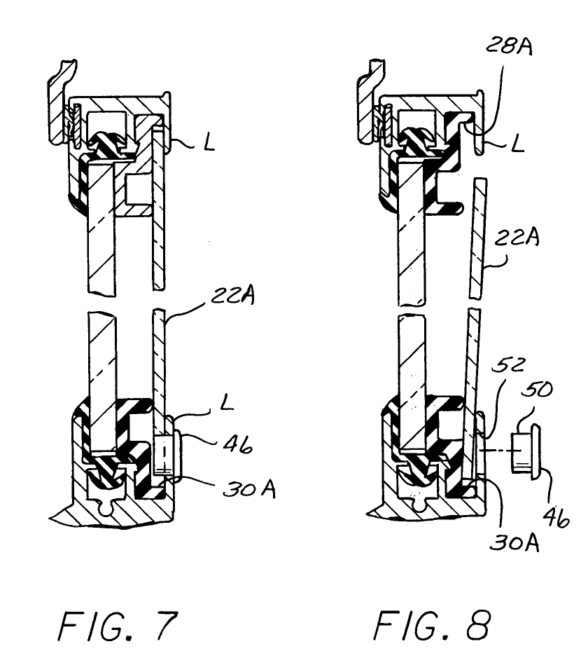

FIGS. 7 and 8 show an arrangement comprised of a series of removable headed plugs 46 insertable in the lip L of the lower channel 30A, the plugs 46 each having a stem 50 protruding through an opening 52 and into the channel 30A to hold the sacrificial gazing panel 22A in an up position.

Upon removal of the plugs 46, the sacrificial glazing panel 22A is lowered sufficiently to clear the lip L of the upper channel 28A, so that upon bowing of the panel 22A, it may be tilted out of removed as described above.

The glazing panels may also be shifted sideways in the frame for removal.

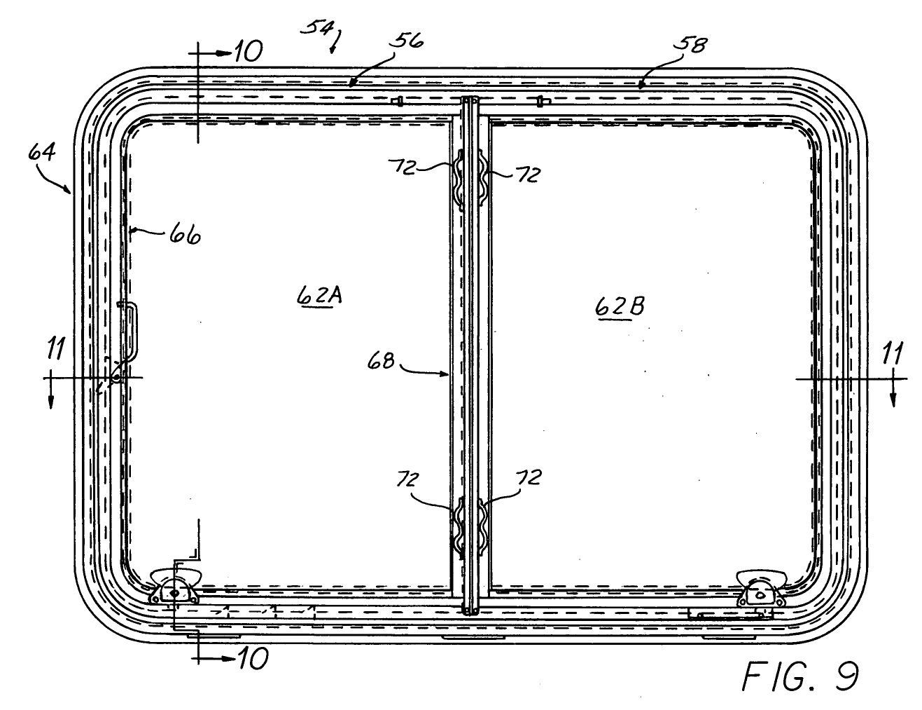

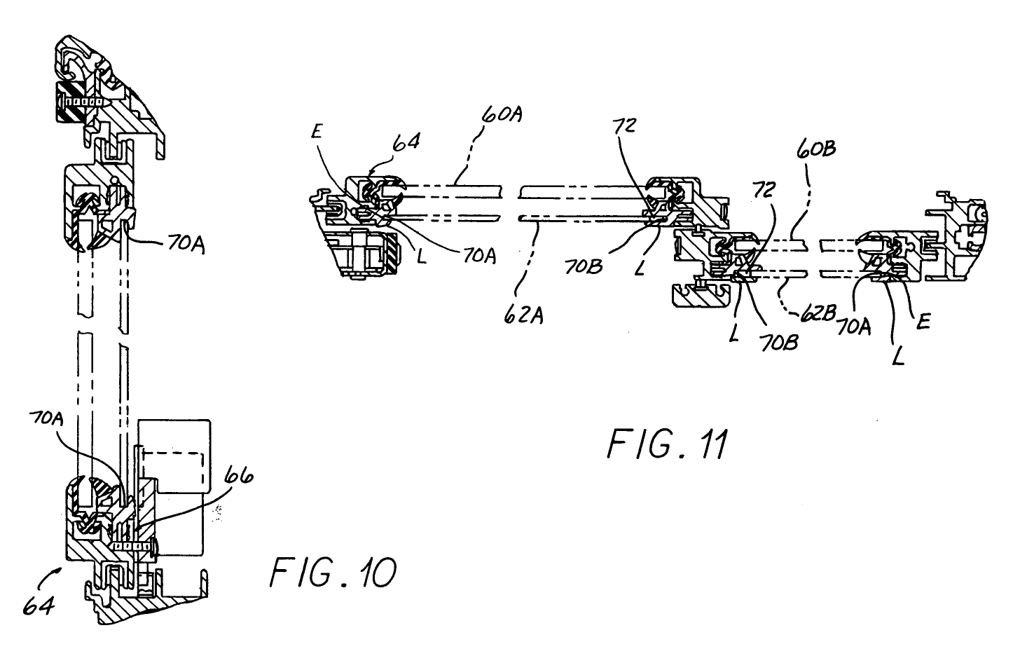

FIGS. 9-11 show a window 54 comprised of a pair of side by side glazing assemblies 56 and 58, each mounted in a frame and seal assembly 64. Each glazing assembly 56, 58 includes a primary glazing panel 60A, 60B and sacrificial glazing panel 62A, 62B mounted in a retainer frame as in the above described embodiments.

A curved corner generally rectangular perimeter frame section 66 and a straight divider frame section 68 respectively define sacrificial glazing panel receiving channel sections 70A, 70B. The vertical divider channel sections 70B are deeper than the opposing perimeter channel sections 70A to allow horizontal shifting movement of the sacrificial glazing panel 62A, 62B during installation and removal as described above, instead of the vertical movement described above.

The divider channel sections 70B each receive pairs of double bowed leaf springs 72 disposed against the bottom wall thereof.

The springs 72 normally position one side edge of the sacrificial glazing panels 62A, 62B so as to be retained by the lip L of the opposite section of the perimeter channel sections 70A in similar fashion to the above described embodiment.

Thus, the panels 62A, 62B can be shifted sideways by compressing the double bowed leaf springs 72 to allow the side edge E to clear the lip L. Upon bowing of the panel 62A, 62B, the top and bottom edges are drawn together to clear the lip L of the top and bottom perimeter channel sections 70A to enable tilting out and removal of the panel 62A or 62B. Installation is carried out in similar fashion.

Thus, a simple and quick installation or removal of sacrificial glazing panels can be carried out with a minimum use of tools.

1. A plastic glazing panel installation comprising:
a generally rectangular glazing panel of transparent plastic having top, bottom and side edges;
a retainer frame defined by sections of a perimeter channel forming a corresponding generally rectangular glazing opening for receiving the edges of said panel, said sections of said perimeter channel each having a lip together defining an opening of smaller size than said glazing opening, so as to retain said panel in said perimeter channel;
said glazing panel being sufficiently thin and flexible to be able to be easily bowed so as to allow opposite edges of said glazing panel to be drawn together sufficiently to be able to be passed by the lips of opposite sections of said perimeter channel and allow another edge of said glazing panel to be inserted in a receiving channel section extending along said glazing opening, said receiving channel section being deeper than an opposite channel section so that upon insertion of said another edge of said glazing panel and movement towards the bottom of said receiving channel section, an edge of said glazing panel opposite said another edge clears said lip of said opposite channel section which is shallower than said receiving channel section to enable insertion and removal of said glazing panel.

2. The installation according to claim 1 wherein said receiving channel section has a resiliently compressible element disposed therein allowing sufficient movement upon pushing of another edge of said glazing panel thereagainst so that said glazing panel edge opposite said another glazing panel edge clears the lip of said opposite channel section allowing removal of said glazing panel, but thereafter upon release causes said glazing panel to be repositioned to locate said another edge of said glazing panel at an intermediate depth in said receiving channel section.

3. The installation according to claim 2 wherein said compressible element comprises a bowed leaf spring disposed in the bottom of said receiving channel section so as to be compressible by said glazing panel another edge.

4. The installation according to claim 2 wherein said compressible element comprises an elastomeric piece.

5. The installation according to claim 4 wherein said elastomeric piece comprises a piece of elastomeric foam.

6. The installation according to claim 4 wherein said elastomeric piece is formed with an opening in a lower portion allowing compression thereof.

7. The installation according to claim 1 wherein said receiving channel section is at the bottom of said glazing opening, and further including a positioner element selectively manipulatable to allow lowering of said glazing panel and thereafter hold said glazing panel another edge at an intermediate position in said channel section so that said opposite edge of said glazing panel does not clear said lip of said channel section opposite said receiving channel section.

8. The installation according to claim 7 wherein said positioner element comprises a compressible element able to be compressed by pushing said glazing panel another edge thereagainst, and thereafter when said glazing panel is released moving said opposite edge of said glazing panel into said one channel section opposite said receiving channel section.

9. The installation according to claim 7 wherein said positioner element comprises a plug in a lip of said bottom channel section, said plug having a stem portion protruding into said bottom channel section normally holding said glazing panel another edge at an elevated position therein but removable to allow lowering of said glazing panel another edge into said bottom channel section.

10. The installation according to claim 1 further including a primary glazing panel installed in said frame adjacent said glazing panel and aligned therewith but spaced to one side, said glazing panel being thinner and made of plastic to comprise a sacrificial glazing panel.

11. The installation according to claim 1 further including positioner means for allowing manipulating movement of said another edge of said glazing panel into said receiving channel section of to a sufficient extent to allow said opposite edge of said glazing panel to clear said lip of said opposite channel section but after release of said glazing panel to thereafter position said another edge of said glazing panel at an intermediate position in said deeper receiving section of said perimeter channel to cause said opposite edge of said glazing panel to be retained by said lip of said opposite channel section.

12. The installation according to claim 11 wherein said positioner means is selected from the group consisting of a compressible leaf spring, a piece of compressible foam, an elastomeric element having an opening allowing ready compression thereof, or a slider-spring combination.

13. A method of installing and removing a generally rectangular glazing panel having top, bottom and side edges corresponding in a generally rectangular frame defining a glazing opening, said frame having a perimeter channel having a top, bottom and a pair of side sections each formed with a lip portion and adapted to receive and retain said glazing panel, said perimeter channel retaining said glazing panel therein, the method including the steps of:
forming a channel on one of said channel sections of said frame to be deeper than an opposite section;
configuring said glazing panel so that it is easily bowed sufficiently to bring together opposite edges thereof sufficiently so as to be insertable into said glazing opening, clearing said lip of each of an opposing first set of perimeter channel sections and thereafter inserting another edge of said glazing panel into another of said channel sections;
said another of said channel sections deeper than a channel section opposite thereto so that said another edge of said panel can be forcibly moved into said another channel section a sufficient distance so that a glazing panel edge opposite said another edge of said glazing panel clears the lip of said channel section opposite thereto;
thereafter positioning said glazing panel in said perimeter channel so as to have both said another and opposite edges of said glazing panel are retained by said lips of said channel sections; and
removing said glazing panel by forcibly moving said another edge of said glazing panel into said deeper perimeter channel section sufficiently so that said glazing panel edge opposite said another edge clears said lip of said opposite channel section, and bowing said glazing panel to bring said set of opposite glazing panels edges together to enable removal of said glazing panel from said perimeter frame.

14. The method according to claim 13 wherein said positioning step includes the step of disposing a compressible locator in said one channel section of said second set of channel sections which allows said one glazing panel edge of said second set of edges to be pushed therein but upon release thereof repositioning said glazing panel another edge at an intermediate depth of said deeper channel section to locate said edge opposite said another edge so as to be retained by said lip of said channel section opposite said deeper channel section.
